(19) United States
(12) Patent Application Publication
(10) Pub. No.: US 2002/0080601 A1
(43) Pub. Date: Jun. 27, 2002

(54) Device for simulating an open fire

(76) Inventor: Otto Wilhelm Meltzer, Kempen (DE)

Correspondence Address: ROSENBERG, KLEIN & LEE, 3458 ELLICOTT CENTER DRIVE-SUITE 101, ELLICOTT CITY, MD, 21043, US

(21) Appl. No.: 09/932,955

(22) Filed: Aug. 21, 2001

(30) Foreign Application Priority Data
Dec. 22, 2000 (DE) 200 21 826.3

(51) Int. Cl. F21V 33/00

(52) U.S. Cl. 362/96; 362/234; 362/806; 362/811

(57) ABSTRACT

A device for the simulation of an open fire, with at least one projection surface and at least one light source illuminating the projection surface, characterized in that the projection surface consists of a light and thin material and that a device for producing an air flow erecting and moving the projection surface with an air flow outlet arranged in the lower area of the projection surface is provided.

### BACKGROUND OF THE INVENTION

The invention relates to a device for the simulation of an open fire, with at least one projection surface and at least one light source illuminating the projection surface.

From practice devices for simulating an open fire are known, which have a vertically arranged screen as a projection surface and a light source simulating the fire in the form of a rotating, particularly color-imprinted cylinder.

The disadvantage here is that the impression of an open fire is created to a limited extent because of the flat and immobile projection surface.

### SUMMARY OF THE INVENTION

It is the object of the invention to avoid said disadvantages and to create a device of the above-mentioned kind, which makes possible a true to life simulation of an open fire.

This task is achieved by means of a device for the simulation of an open fire with at least one projection surface and at least one light source illuminating the projection surface, wherein the projection surface consists of a light and thin material and a device for producing an air flow erecting and moving the projection surface is provided, having an outlet for the air flow in the lower area of the projection surface. Hereby, due to the moving projection surface, a live impression is created is given, which simulates particularly well the effects of an actual open fire.

Preferably a fan can be used as a device for the production of the air flow, but also other devices, such as a roller or radial fan blower, a piston pump or bellows, or the like can be provided. As long as the projection surface is light enough, even the heat radiation of the light source can create a sufficiently strong airflow, under certain circumstances.

Also the airflow produced by the device can ventilate and cool the light source.

According to the invention, the air flow outlet can be formed by at least one air guide channel, so that the device for the production of the air flow can be arranged at a distance from the air flow outlet.

Thereby the air guide channel can be designed as a hollow space facing the orientation and extent of the projection surface(s). As long as there are not several air guide channels, the hollow space can have divider walls or the like, by means of which the air flow can either be set to rotate, or a rotation generated by the device for producing the air flow can be attenuated.

Thereby the air guide channel can consist particularly of a plurality of neighboring hollow spaces shaped like hollow cylinders, which are arranged above a fan.

Advantageously the projection surface can be a cylinder shell, particularly a regular cylinder shell, so that through a corresponding three-dimensional design a simulation of an open fire is achieved, which appears particularly close to reality.

In a preferred embodiment of the invention, the projection surface can consist of several strip-like partial projection surfaces, so that through independent motions of the partial projection surfaces a particularly lifelike and real simulation of an open fire results.

Also the projection surface can be imprinted with colors, similar to a fire and/or at least one light source can be provided as a colored illuminating device.

Preferably several, particularly differently colored illuminating devices can be provided, whereby the illuminating devices can illuminate different areas.

According to the invention, the device can be integrated in a fireplace or in a stove-like housing.

Also the device can be arranged in a bowl-like housing, particularly mounted on top of a column, or the device can be integrated in a piece of furniture, particularly in a table.

Thereby the device can be covered on top by a transparent plate, particularly made of glass or acrylic glass, so that on the one hand the device is protected against external influences and contamination, and on the other hand the area above the device can be used also for instance as a space for placing objects.

Preferably the projection surface is made of silk, particularly parachute silk or of synthetic silk.

### BRIEF DESCRIPTION OF THE DRAWINGS

In the following embodiment examples of the invention illustrated in the drawing are explained. It shows:

FIG. 1 a first embodiment example of a device according to the invention,

FIG. 2 a further embodiment example of a device according to the invention

FIG. 3 a top view of the object in FIG. 1,

FIG. 4 a top view of a further device according to the invention,

FIG. 5 a top view on the object of FIG. 2.

### DETAILED DESCRIPTION OF THE PREFERED EMBODIMENT

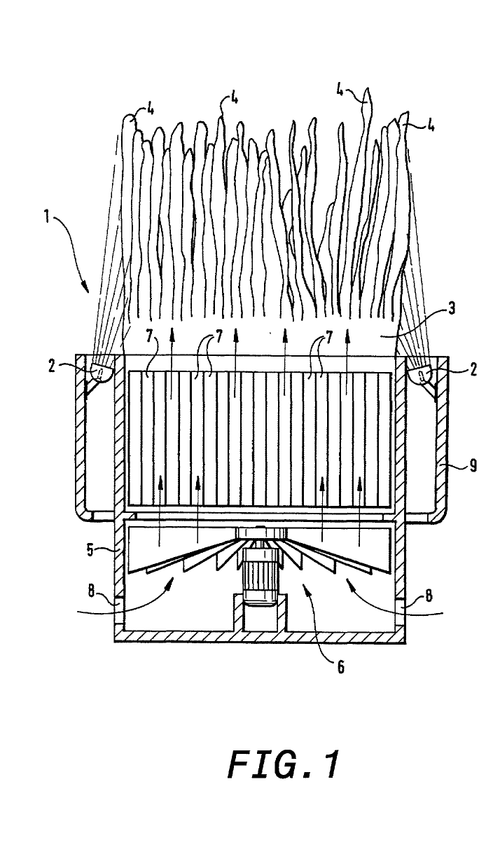

FIG. 1 shows a device 1 with light sources 2 and a projection surface 3 consisting of a light and thin material. Thereby the projection surface 3 consists of silk and has at least partially strip-like partial projection surfaces 4.

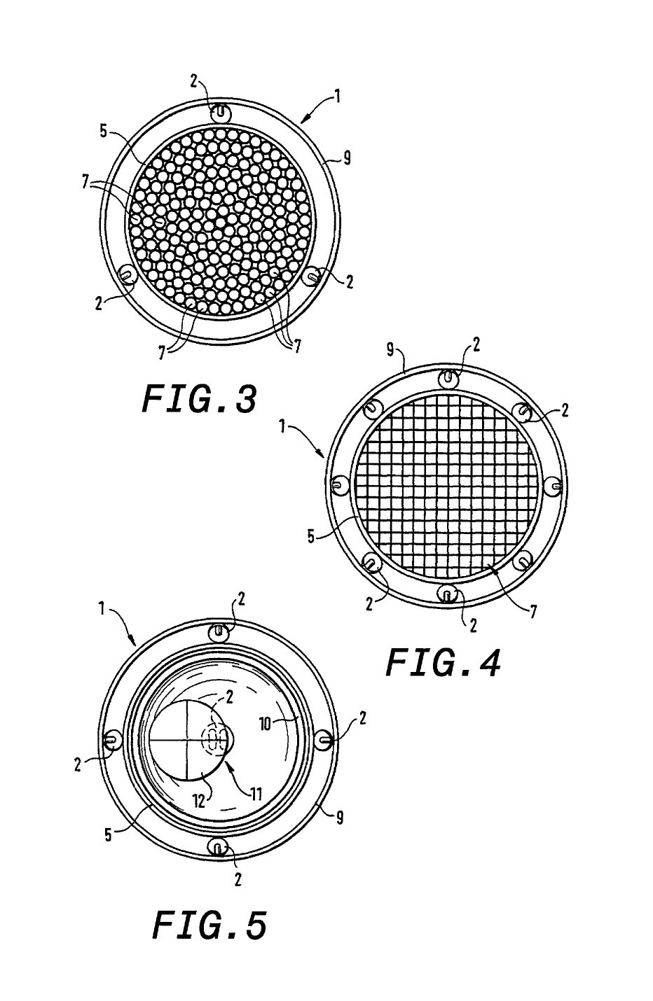

The device 1 is a hollow body shaped substantially like a circular cylinder wherein a fan 6 is arranged, which pushed airflow through a multitude of air guide channels 7. At the upper rim of the housing 5, the projection surface 5 shaped like a hollow regular cylinder shell is arranged. Air inlet openings 8 as well as an outer shell ring 9 are provided in the housing 5, whereby in the outer shell ring 9 the light sources 2 are arranged, which illuminate the partial projection surfaces 4. FIG. 3 shows a top view on the object of FIG. 1.

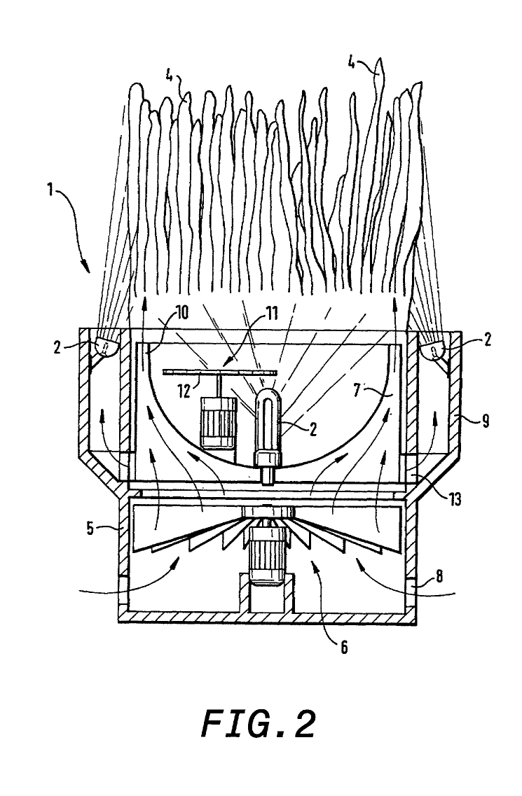

FIG. 2 shows a further embodiment example of a device 1 according to the invention, wherein the air guide channel 7 has at its upper end a circular air flow outlet 10, in whose center a colored illuminating device 11 is provided, consisting of a light source 2 and a color changer 12. Through an additional channel 13 the light sources 2 located in the outer shell ring 9 are surrounded by the airflow and thereby cooled. Thereby the light sources 2 located in the outer shell ring 9 can for instance radiate a blue or blue-yellow light projected only upon the outer border area of the partial projections 4, while the center light source 2 of the illuminating device 11 radiates read and orange, as well as yellow shades. Insofar the basic color shade of the “fire” is red to red-yellow, and the bluish effects represent licking flames.

FIG. 5 shows a top view of the object of FIG. 2.

FIG. 4 shows a top view of a further device 1 according to the invention, wherein a grid structure is provided as an air guide channel 7.

What is claimed is:

1. A device for simulation of an open fire, comprising at least one projection surface and at least one light source illuminating the projection surface, characterized in that the projection surface formed by a light and thin material and a device for producing an air flow erecting and moving the projection surface with an air flow outlet arranged in a lower area of the projection surface is provided.

2. The device according to claim 1, characterized in that a fan is used as the device for producing the air flow.

3. The device according to claims 1, characterized in that the air flow outlet is formed by an air guide channel.

4. The device according to claims 1, characterized in that the projection surface is shaped like a cylinder shell, particularly to a regular cylinder shell.

5. The device according to claims 1, characterized in that the projection surface comprise several, particularly strip-like partial projection surfaces.

6. The device according to claims 1, characterized in that the projection surface is imprinted with colors in a fire-like manner.

7. The device according to claims 1, characterized in that at least one light source is provided as a colored illumination device.

8. The device according to claims 7, characterized in that several, particularly differently colored illumination devices are provided.

9. The device according to claim 8, characterized in that the illumination devices illuminate different areas.

10. The device according to claims 2, characterized in that the device is integrated in a fireplace or a stove-like housing.

11. The device according to claims 1, characterized in that the device is arranged in a bowl-like housing, particularly mounted on a top of a column.

12. The device according to clams 1, characterized in that the device is integrated in a piece of furniture, particularly to a table.

13. The device according to claim 11, characterized in that the device is covered on a top by a transparent plate, particularly to glass or acrylic glass.

14. The device according to one of claims 1, characterized in that the projection surface is made of silk, particularly to parachute silk or synthetic silk.
